(19) United States
(12) Patent Application Publication
(10) Pub. No.: US 2006/0124430 A1
(43) Pub. Date: Jun. 15, 2006

(54) Segment-type wet friction material, its manufacturing apparatus and its manufacturing method

(75) Inventors: Masayuki Mizuno, Seto-shi (JP); Masaki Tominaga, Kasugai-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: AISINKAKO KABUSHIKI KAISHA, Aichi (JP)

(21) Appl. No.: 11/099,700

(22) Filed: Apr. 6, 2005

(30) Foreign Application Priority Data
Apr. 7, 2004 (JP) 2004-113265

(51) Int. Cl. F16D 13/60

(52) U.S. Cl. 192/107 M

(57) ABSTRACT

In manufacturing a segment-type wet friction material, each segment piece in a guide is pushed out and mounted on a rotating plate. Cut portions at opposite outer peripheral corners of the segment piece are fitted and engaged with two positioning pins so as to position the segment piece on the rotating plate. The segment piece is sucked by a pair of positioning suction holes located thereunder so as to be fastened. The rotating plate is turned 18 degrees and such operation is repeated until twenty segment piece are charged in a ring shape. Then, each two suction heads of a sucking/moving mechanism sucks surfaces of each segment piece. At the same time, a sucking operation of the positioning suction holes is stopped. Then, the twenty segment pieces arranged in the ring shape is lifted by the sucking/moving mechanism and moved in parallel to a core metal with an adhesive coated on an entire surface thereof. The twenty segment pieces are pressed to the core metal so as to adhere thereto.

### BACKGROUND OF THE INVENTION

1. Field of the Invention

This invention relates to a wet friction material that generates a torque by applying a high pressure to an opposite surface while being immersed in an oil. In detail, this invention relates to a segment-type wet friction material made by joining friction material substrates that were cut into a segment piece onto one or both of opposite surfaces of a core metal of a flat ring shape along an entire circumference thereof with an adhesive, as well as to its manufacturing apparatus and its manufacturing method. Particularly, this invention relates to a segment-type wet friction material having an equal property to that of a ring-type friction material, as well as to its manufacturing apparatus and its manufacturing method.

2. Description of the Related Art

In recent years, a segment-type friction material 27 as shown in FIG. 13 is under development as a wet friction material in order to improve material yield with resultant cost reduction and to lessen drag torque with resultant high fuel efficiency. FIG. 10 is a plan view showing an overall structure of a conventional segment-type friction material. As shown in FIG. 13, the segment-type friction material 27 has a core metal 2 of a flat ring shape and friction material substrates 28. The friction material substrates 28 are cut into a segment piece corresponding to and arranged along the flat ring shape. A set of the segment-piece-shaped friction material substrates 28 are arranged and joined with an adhesive on a front surface of the core metal 2 side by side along an entire circumference of the core metal 2 with a gap to be an oil groove. Another set of the segment-piece-shaped substrates 28 are joined with the adhesive to a rear surface of the core metal 2, too. Such segment-type friction material 27 is applicable to a friction material clutch device that has a single or plural friction plates and that is used in an automatic transmission, which may be referred to as “AT” hereafter, of automobiles or motorcycles or the like.

A ring-type friction material 25 is used for another part of the automatic transmission. As shown in FIG. 12, the ring-type friction material 25 has a friction material substrate 23 cut into a ring shape joined with an adhesive on opposite surfaces or one surface of a core metal 22 of a flat ring shape. FIG. 12 is a plan view showing an overall structure of the conventional ring-type friction material 25. There is a difference in frictional property between the segment-type friction material 27 and the ring-type 25. Therefore, these two types of the wet friction material are used differently according to an application. Japanese Laid Open Patent Publication No. 2001-90746 discloses an invention of a manufacturing method and a manufacturing apparatus that can stick segment pieces on a core metal of a flat ring shape without displacement at the time of manufacturing a segment-type friction material.

However, the conventional manufacturing method has a step for sticking the segment piece on the core metal of the flat ring shape while applying an adhesive on the segment piece each time the segment piece is cut out. Such step is repeated to the number of the segment pieces. Consequently, a property of the adhesive varies at the beginning and the end of such plural steps, so that a sticking condition of the segment piece varies accordingly. As a result, there arises a problem that a sticking position of the segment piece is sometimes displaced. In view of that, the applicant of the present patent application solves such problem by applying an adhesive at a time on an entire circumference of the core metal of the flat ring shape and then sticking all the segment pieces at a time after housing all the segment pieces in a circumferential manner in a holding member in the above patent publication No. 2001-90746.

However, as shown in FIG. 11, the ring-shaped friction material substrates of the ring-type friction material are cut out from a band-shaped friction material substrate 21. Therefore, it has a bad material yield such as 10 to 20% and its cost reduction is difficult. FIG. 11 is a plan view showing a way of cutting out the ring-shaped friction material substrate of the conventional ring-type friction material from the band-shaped friction material substrate.

Then, it is possible that the segment-type friction material is given a similar frictional property to that of the ring-type friction material by making very small or eliminating a gap between adjacent segment pieces of the segment-type friction material. However, there is a problem in the conventional manufacturing apparatus and the manufacturing apparatus described in the above-mentioned patent publication 2001-90746 that the segment pieces cannot be disposed or stuck unless a gap is provided between the adjacent segment pieces.

### BRIEF SUMMARY OF THE INVENTION

It is an object of the present invention to provide a segment-type friction material, its manufacturing apparatus and its manufacturing method that can give a segment-type friction material a frictional property similar to that of a ring-type friction material by making very small or eliminating a gap between adjacent segment pieces of a segment friction material, thereby reducing costs.

According to a first aspect of the invention, there is provided a segment-type wet friction material comprising: a core metal of a flat ring plate shape; and segment pieces made of a friction material substrate cut into a segment piece shape along a circumference of the flat ring plate shape of the core metal, the segment pieces being joined on at least one surface of the core metal with an adhesive, and the segment pieces being arranged side by side and in close contact with each other along the entire circumference of the core metal so as to substantially eliminate a gap between adjacent two of the segment pieces.

Preferably, each of the segment pieces has a same shape and a same dimension; each of the segment pieces has a left side, a right side, an outer peripheral side and an inner peripheral side, while the left side and the right side of the segment piece making a prescribed angle; and the prescribed angle made by the left side and the right side of each of the segment pieces is determined so that a predetermined number of the segment pieces are to be arranged side by side and in close contact with each other along the entire circumference of the core metal so as to substantially eliminate a gap between adjacent two of the segment pieces.

Preferably, the prescribed angle made by the left side and the right side of each of the segment pieces is eighteen degrees and twenty segment pieces as the predetermined number of the segment pieces are arranged side by side and in close contact with each other along the entire circumference of the core metal so as to substantially eliminate a gap between adjacent two of the segment pieces.

Preferably, the prescribed angle made by the left side and the right side of each of the segment pieces is nine degrees and forty segment pieces as the predetermined number of the segment pieces are arranged side by side and in close contact with each other along the entire circumference of the core metal so as to substantially eliminate a gap between adjacent two of the segment pieces.

Preferably, the segment pieces are disposed in a predetermined number side by side and in close contact to each other on a same plane so as to form a ring shape corresponding to the flat ring plate shape of the core metal, while each of the predetermined number of the segment pieces being positioned at a fixed location on the same plane, and the predetermined number of the segment pieces formed in the ring shape are integrally moved to the surface of the core metal so as to be joined thereto with the adhesive; and each of the segment pieces has a reference point or a reference line that acts to position the same segment piece at the fixed location on the same plane.

Preferably, the segment piece has a cut portion acting as the reference point, the cut portion being provided at a fixed position of a periphery of the segment piece.

Preferably, the predetermined number of the segment pieces are disposed side by side and in close contact to each other on a same plane so as to form a ring shape corresponding to the flat ring plate shape of the core metal, while each of the predetermined number of the segment pieces being positioned at a fixed location on the same plane, and the predetermined number of the segment pieces formed in the ring shape are integrally moved to the surface of the core metal so as to be joined thereto with the adhesive; and each of the segment pieces has a reference point or a reference line that acts to position the same segment piece at the fixed location on the same plane.

Preferably, the segment piece has a cut portion acting as the reference point, the cut portion being provided at a fixed position of at least one of the left side, the right side, the outer peripheral side and the inner peripheral side of the segment piece.

Preferably, the fixed position and a shape of the cut portion of each of the predetermined number of the segment pieces is determined such that the cut portion is fitted and engaged with a positioning pin provided on the same plane when the predetermined number of the segment pieces are disposed side by side on the same plane, thereby enabling each of the predetermined number of the segment pieces to be positioned at each of the fixed locations on the same plane.

Preferably, a pair of the cut portions is provided at an outer left corner between the left side and the outer peripheral side and at an outer right corner between the right side and the outer peripheral corner of the segment piece, the pair of the cut portions being made by symmetric short straight lines that extend in parallel to each other while crossing the left side and the right side at a small angle at outer ends of the left side and the right side, respectively.

Preferably, a pair of the cut portions is provided at an inner left corner between the left side and the inner peripheral side and at an inner right corner between the right side and the inner peripheral corner of the segment piece, the pair of the cut portions having symmetric shapes, respectively, that are obtained by dividing an ellipse or a slot into four and that extend along the left side and the right side at inner ends thereof.

Preferably, a pair of the cut portions is provided at the inner peripheral side of the segment piece, the pair of the cut portions being separated at a half angle of the prescribed angle made by the left side and the right side of the segment piece.

Preferably, the inner peripheral side of the segment piece defines the reference line.

Preferably, the outer peripheral side and the inner peripheral side of the segment piece has substantially a same curvature.

According to a second aspect of the invention, there is provided a manufacturing apparatus of a segment-type wet friction material, that is suitable for a manufacturing apparatus of the aforementioned segment-type wet friction material, comprising: a rotating plate of a ring shape corresponding to the core metal, the rotating plate being able to arrange and set the segment pieces side by side and in close contact with each other along an entire circumference thereof so as to substantially eliminate a gap between adjacent two of the segment pieces; and a guide for guiding a movement of the segment piece to the rotating plate; wherein the rotating plate has positioning pins erected thereon in a predetermined number larger than a number of the segment pieces joined on one surface of the core metal, the rotating plate has positioning suction holes provided in a predetermined number larger than the number of the segment pieces, each of the positioning pins fits into the cut portion of each of the segment pieces guided from the guide and set on the rotating plate so as to position the segment piece at a fixed location of the rotating plate, and each of the positioning suction holes sucks each of the segment pieces positioned at the fixed location so as to keep the segment piece fastened at the fixed location.

Preferably, the guide guides the movement of the segment piece one by one to the rotating plate, each of the positioning pins of the rotating plates is disposed at a position matching each of the cut portions of each of the segment pieces guided to the rotating plate, and the positioning pins are provided in a same number as a number of the cut portions of the segment pieces.

According to a third aspect of the invention, there is provided a manufacturing apparatus of a segment-type wet friction material, that is suitable for a manufacturing apparatus of the aforementioned segment-type wet friction material, comprising: a rotating plate of a ring shape corresponding to the core metal, the rotating plate being able to arrange and set the segment pieces side by side and in close contact with each other along an entire circumference thereof so as to substantially eliminate a gap between adjacent two of the segment pieces; and a guide for guiding a movement of the segment piece to the rotating plate; wherein the rotating plate has positioning suction holes provided thereon in a predetermined number larger than a number of the segment pieces joined on one surface of the core metal and control means for detecting an inner peripheral side as the reference line of each of the segment pieces guided from the guide and set on the rotating plate and then operating the positioning suction holes when the inner peripheral side coincides with an inner circumferential edge of the rotating plate so as to sucking the segment piece by the positioning suction hole and thereby to position the segment piece on a fixed location of the rotating plate.

According to a fourth aspect of the invention, there is provided a manufacturing method of a segment-type wet friction material, that is suitable for a manufacturing method of the aforementioned segment-type wet friction material, comprising: a cutting step for cutting the segment pieces from the friction material substrate into the segment piece shape; a setting step for guiding a movement of the segment pieces to a rotating plate one by one via a guide so as to position each of the segment pieces at a fixed location of the rotating plate and sucking each of the segment pieces positioned at the fixed location by a positioning suction hole provided on the rotating plate so as to keep each of the segment pieces fastened at the fixed location, the setting step being repeated by a number of the segment pieces arranged on one surface of the core metal so as to arrange and set the segment pieces side by side and in close contact with each other along an entire circumference thereof and so as to substantially eliminate a gap between adjacent two of the segment pieces; a sucking step for integrally sucking and holding all the segment pieces arranged side by side on the rotating plate by all suction heads of a sucking/moving mechanism, while stopping sucking operation of the positioning suction holes of the rotating plate, after the rotating plate turns 360 degrees and all the segment pieces are arranged in close contact with each other into the ring shape; and an adhering step for integrally lifting and moving in parallel all the segment pieces arranged into the ring shape to the core metal with the adhesive coated on one surface and then integrally pressing and joining all the segment pieces to the core metal via the sucking/moving mechanism.

According to a fifth aspect of the invention, there is provided a manufacturing method of a segment-type wet friction material, that is suitable for a manufacturing method of the aforementioned segment-type wet friction material, comprising: a cutting step for cutting the segment pieces from the friction material substrate into the segment piece shape; a setting step for guiding a movement of the segment pieces to a rotating plate one by one via a guide so as to make each of positioning pins erected on the rotating plate in each of the cut portions of each of the segment pieces thereby to position each of the segment pieces at a fixed location of the rotating plate and sucking each of the segment pieces positioned at the fixed location by a positioning suction hole provided on the rotating plate so as to keep each of the segment pieces fastened at the fixed location, the setting step being repeated by a number of the segment pieces arranged on one surface of the core metal so as to arrange and set the segment pieces side by side and in close contact with each other along an entire circumference thereof and so as to substantially eliminate a gap between adjacent two of the segment pieces; a sucking step for integrally sucking and holding all the segment pieces arranged side by side on the rotating plate by all suction heads of a sucking/moving mechanism, while stopping sucking operation of the positioning suction holes of the rotating plate, after the rotating plate turns 360 degrees and all the segment pieces are arranged in close contact with each other into the ring shape; and an adhering step for integrally lifting and moving in parallel all the segment pieces arranged into the ring shape to the core metal with the adhesive coated on one surface and then integrally pressing and joining all the segment pieces to the core metal via the sucking/moving mechanism.

According to a fifth aspect of the invention, there is provided a manufacturing method of a segment-type wet friction material, that is suitable for a manufacturing method of the aforementioned segment-type wet friction material, comprising: a cutting step for cutting the segment pieces from the friction material substrate into the segment piece shape; a setting step for guiding a movement of the segment pieces to a rotating plate one by one via a guide, then detecting an inner peripheral side as the reference line of each of the segment pieces so as to operate a positioning suction hole provided on the rotating plate so as to suck the segment piece and to keep the segment piece fastened at a fixed location of the rotating plate, the setting step being repeated by a number of the segment pieces arranged on one surface of the core metal so as to arrange and set the segment pieces side by side and in close contact with each other along an entire circumference thereof and so as to substantially eliminate a gap between adjacent two of the segment pieces; a sucking step for integrally sucking and holding all the segment pieces arranged side by side on the rotating plate by all suction heads of a sucking/moving mechanism, while stopping sucking operation of the positioning suction holes of the rotating plate, after the rotating plate turns 360 degrees and all the segment pieces are arranged in close contact with each other into the ring shape; and an adhering step for integrally lifting and moving in parallel all the segment pieces arranged into the ring shape to the core metal with the adhesive coated on one surface and then integrally pressing and joining all the segment pieces to the core metal via the sucking/moving mechanism.

The segment-type wet friction material according to the invention obtains a similar property such as a frictional characteristic to that of the ring-type friction material by sticking the segment pieces along the entire circumference of the core metal without making a gap to be an oil groove, while reducing the costs largely.

In case of making the outer peripheral side and the inner peripheral side of the segment piece substantially the same curvature, it is possible to cut out the segment pieces successively in an up-and-down direction from a band-like friction material substrate. Moreover, it is possible to cut out the segment pieces successively in a right-and-left direction only by providing a small space in the right-and-left direction of the substrate. Thus, a material yield can be improved up to about 80 to 90%, thereby reducing the costs largely.

The manufacturing method of the segment-type wet friction material according to the invention can arrange the segment pieces into the ring shape on the core metal with a very small gap or without any gap. At this time, the segment pieces are never displaced and firmly adhere to the core metal of the flat ring plate shape. In case of a both-side type, the same steps are repeated. Thus, the segment pieces are joined with the adhesive into the ring shape on both surfaces of the core metal, respectively. Such segment-type friction material has a similar property to the ring-type friction material.

In case of providing the cut portion at the outer peripheral side of the segment piece, a circumference without any dents is formed at an inner circumferential side of the ring-shaped segment pieces. Then, it can be expected that the segment-type friction material has a similar property to that of the ring-type friction material when a lubricating oil or an automatic transmission fluid, which may be referred to as “ATF” hereafter, is supplied from an inside. Moreover, in such segment-type friction material, it is possible to cut out the segment pieces successively from a band-like friction material substrate with a very small interval. Thus, a material yield can be improved up to about 80 to 90%, thereby reducing the costs largely.

In case of providing the cut portion at the inner peripheral side of the segment piece, the cut portion can be smaller than in case of providing the cut portion at the outer peripheral side. Then, a friction material area of the segment-type friction material can be larger accordingly. Moreover, dents at which the ATF remains are formed at the inner circumferential side of the ring-shaped segment pieces along an entire circumference thereof. Thus, it is expectable that the frictional characteristic at the time of engagement of the segment-type friction material becomes smoother than the ring-type friction material. In addition, in such segment-type friction material, it is possible to cut out the segment pieces successively from a band-like friction material substrate with a very small interval. Thus, a material yield can be improved up to about 80 to 90%, thereby reducing the costs largely.

In case of providing no cut portions on the segment piece, the segment pieces are positioned only by the positioning suction holes at the time of positioning. However, a sufficiently precise positioning is possible. Moreover, since there are no cut portions, the friction material area of the segment-type friction material can be made larger accordingly. Furthermore, a circumference without any dents is formed at an inner circumferential side of the ring-shaped segment pieces. Then, it can be expected that the segment-type friction material has a similar property to that of the ring-type friction material when the ATF is supplied from the inside. In addition, since the positioning pins are unnecessary, a structure of a positioning device is simplified. In such segment-type friction material, it is possible to cut out the segment pieces successively from a band-like friction material substrate with a very small interval. Thus, a material yield can be improved up to about 80 to 90%, thereby reducing the costs largely.

Further objects and advantages of the invention will be apparent from the following description, reference being had to the accompanying drawings, wherein preferred embodiments of the invention are clearly shown.

### BRIEF DESCRIPTION OF THE SEVERAL VIEWS OF THE DRAWINGS

FIG. 1 is a plan view showing a segment piece of a segment-type friction material and its manufacturing method according to a first embodiment of the invention.

FIG. 2 is a plan view showing a half of an arranging device for aligning the segment pieces of the segment-type friction material according to the first embodiment of the invention.

FIG. 3 is a plan view showing a finished segment-type friction material of the first embodiment of the invention.

FIG. 4 is a plan view showing a segment piece of a segment-type friction material and its manufacturing method according to a second embodiment of the invention.

FIG. 5 is a plan view showing a half of an arranging device for aligning the segment pieces of the segment-type friction material according to the second embodiment of the invention.

FIG. 6 is a plan view showing a finished segment-type friction material of the second embodiment of the invention.

FIG. 7 is a plan view showing a segment piece of a segment-type friction material and its manufacturing method according to a third embodiment of the invention.

FIG. 8 is a plan view showing a half of an arranging device for aligning the segment pieces of the segment-type friction material according to the third embodiment of the invention.

FIG. 9 is a plan view showing a finished segment-type friction material of the third embodiment of the invention.

FIG. 10 is a plan view showing a segment piece of a segment-type friction material and its manufacturing method according to a fourth embodiment of the invention.

FIG. 11 is a plan view showing a way of cutting out a ring-shaped friction material substrate of a conventional ring-type friction material from a band-shaped friction material substrate.

FIG. 12 is a plan view showing an overall structure of the conventional ring-type friction material.

FIG. 13 is a plan view showing an overall structure of a conventional segment-type friction material.

FIG. 14 is a schematic view showing a test device for evaluate a frictional property of a segment-type friction material.

FIG. 15 is a graph showing an evaluation result of a standard load duration evaluation.

FIG. 16 is a graph showing an evaluation result of a μ-P-T performance evaluation.

### DETAILED DESCRIPTION OF THE INVENTION

An embodiment of the invention is described referring to the attached drawings.

### FIRST EMBODIMENT

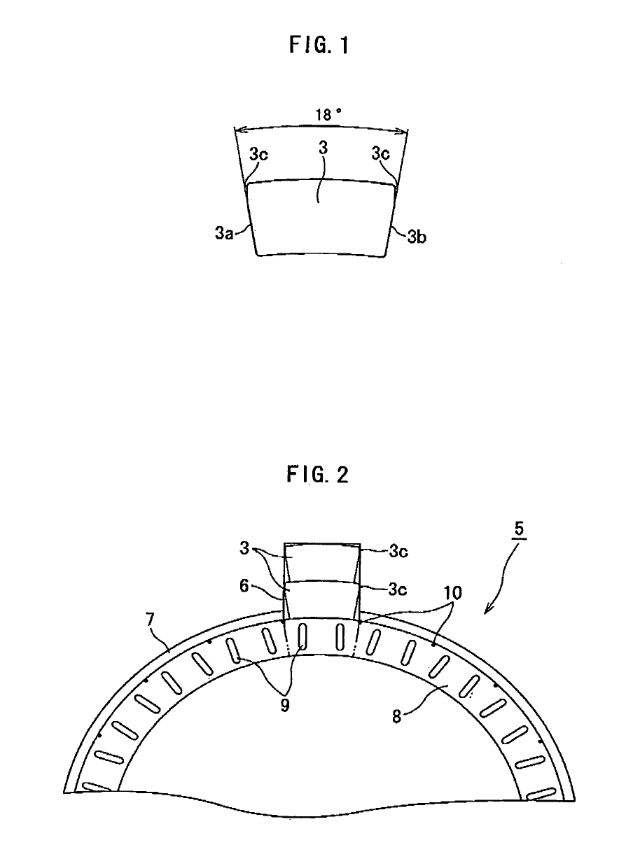

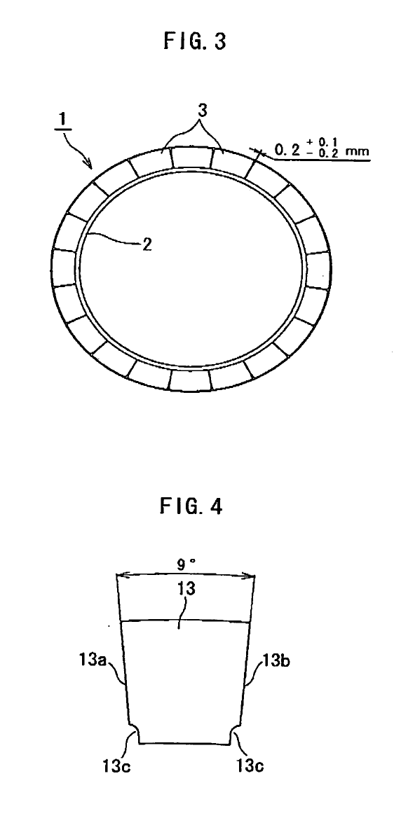

A segment-type friction material and its manufacturing method according to a first embodiment of the invention is described referring to FIG. 1 to FIG. 3. FIG. 1 is a plan view showing a segment piece of a segment-type friction material and its manufacturing method according to a first embodiment of the invention. FIG. 2 is a plan view showing a half of an arranging device for aligning the segment pieces of the segment-type friction material according to the first embodiment of the invention. FIG. 3 is a plan view showing a finished segment-type friction material of the first embodiment of the invention.

As shown in FIG. 1, the segment-type friction material 1 according to the first embodiment is composed of segment pieces 3. The segment pieces 3 have a left side 3a and a right side 3b that make an angle of 18 degrees therebetween. The segment-type friction material 1 has the segment pieces 3 arranged circumferentially and close to each other on one surface of a core metal 2. That is, an adjacent pair of the segment pieces 3 is disposed with very small gap or without a gap therebetween. Accordingly, a number of division of the segment pieces 3 in the ring-shaped segment-type friction material 1 becomes a number obtained by dividing a circumferential angle or 360 degrees by a center angle of each segment piece 3 or 18 degrees: 360/18=20 segments. Thus, the one surface the segment-type friction material 1 is composed of twenty segment pieces 3. Cut portions or notches 3c are provided on opposite outer peripheral corners of the segment piece 3, respectively. The left and right notches 3c are made by symmetric short straight lines that extend in parallel to each other while crossing the left side 3a and the right side 3b at a small angle at outer ends of the left side 3a and the right side 3b, respectively. Thus, a small triangular space is provided between the notches 3c of the adjacent segment pieces 3.

As shown in FIG. 2, the segment pieces 3 of such shape are disposed so as to make a ring shape as a whole by use of an arranging device 5. The arranging device 5 has a guide 6, an outside diameter guide 7 and a rotating device 8. The rotating plate 8 has an inside diameter and an outside diameter nearly equal to those of the core metal 2 of flat ring plate shape constituting the segment-type friction material 1. The rotating plate 8 determines and rotates 18 degrees at a time. Positioning suction holes 9 are provided as forty through holes of an oval or slot shape extending along a radial direction of the rotating plate 8. The suction holes 9 do vacuum suck so as to fasten the arranged segment pieces 3 without displacement. Positioning pins 10 are put in an upright position near an outer circumference of the rotating plate 8 at every 18 degrees of the rotating plate 8. The guide 6 is connected to the rotating plate 8 so as to push out the segment pieces 3 one by one onto the rotating plate 8 by a not-shown pushing member. The outside diameter guide 7 is provided along the entire outer circumference of the rotating plate 8 except a part corresponding to the guide 6.

The segment pieces 3 are fed in the guide 6 in order. A head segment piece 3 is pushed out by the not-shown pushing member so as to be mounted on the rotating plate 8. At this time, the positioning pins 10 of the rotating plate 8 are located at positions where the notches 3c are provided at the opposite outer peripheral corners of the segment piece 3. Then, the pushed out segment piece 3 makes the notches 3c at the opposite outer peripheral corners fitted on two positioning pins 10, respectively. Thus, the segment piece 3 is positioned on the rotating plate 8. That is, each of the notches 3c of the segment piece 3 has such a shape as is engaged with the positioning pin 10 when the segment piece 3 is pushed out to the rotating plate 8, thereby positioning the segment piece 3. Then, the segment piece 3 positioned on a fixed location of the rotating plate 8 is vacuum-sucked through a pair of the positioning suction holes 9 that is located on a lower surface of the segment piece 3. Thus, the segment piece 3 is fastened on the rotating plate 8. In such state, the rotating plate 8 rotates 18 degrees. Then, a next segment piece 3 is pushed out, mounted on the rotating plate 8 and vacuum-sucked to be fastened at a fixed position.

A not-shown sucking/moving mechanism is disposed so as to face an upper surface of the rotating plate 8. The sucking/moving mechanism has forty suction heads. Each adjacent two of the forty suction heads are disposed so as to face each of the segment pieces 3 mounted on the rotating plate 8, respectively. When the above-described step is repeated and the rotating plate 8 goes into a 360 degrees role, twenty segment pieces 3 are charged on the rotating plate 8 in a ring shape as a whole. Then, each two of all the suction heads of the sucking/moving mechanism suck the front surface of each of the segment piece 3. At the same time, a sucking operation of the positioning suction holes 9 of the rotating plate 8 is stopped. The twenty segment pieces 3 disposed in a ring shape are lifted by the sucking/moving mechanism and moved in parallel to the core metal 2 of the flat ring plate shape with an adhesive of a thermosetting synthetic resin applied on an entire front surface thereof. Then, the twenty segment pieces 3 are pressed to the core metal 2 so as to adhere to the front surface of the core metal 2.

Next twenty segment pieces 3 are positioned on the rotating plate 8 by the same step. The twenty segment pieces 3 disposed in a ring shape are lifted by the sucking/moving mechanism in the same manner and moved in parallel to a rear surface of the core metal 2 that has the twenty segment pieces 3 stuck on the front surface in the previous step. At this time, an adhesive is coated on an entire rear surface of the core metal 2. Then, the segment pieces 3 are pressed to the core metal 2 so as to adhere to the rear surface of the core metal 2. In such step, the core metal 2 with the twenty segment pieces 2 stuck to the front surface is turned upside down beforehand, for example. Then, the segment pieces 3 are pressed by a heat-press of 230° C. to 270° C. for 20 to 90 seconds from opposite surfaces of the core metal 2. Thus, the segment pieces 3 are firmly fixed on the opposite surfaces of the core metal 2. Thereby, the segment-type friction material 1 shown in FIG. 3 is obtained. As shown in FIG. 3, a gap between the adjacent segment pieces 3 of the segment-type friction material 1 falls within a range of 0.2 mm plus 0.1 mm or minus 0.2 mm.

A frictional characteristic or property of the segment-type friction material 1 will be described later collectively in comparison with the other embodiments.

### SECOND EMBODIMENT

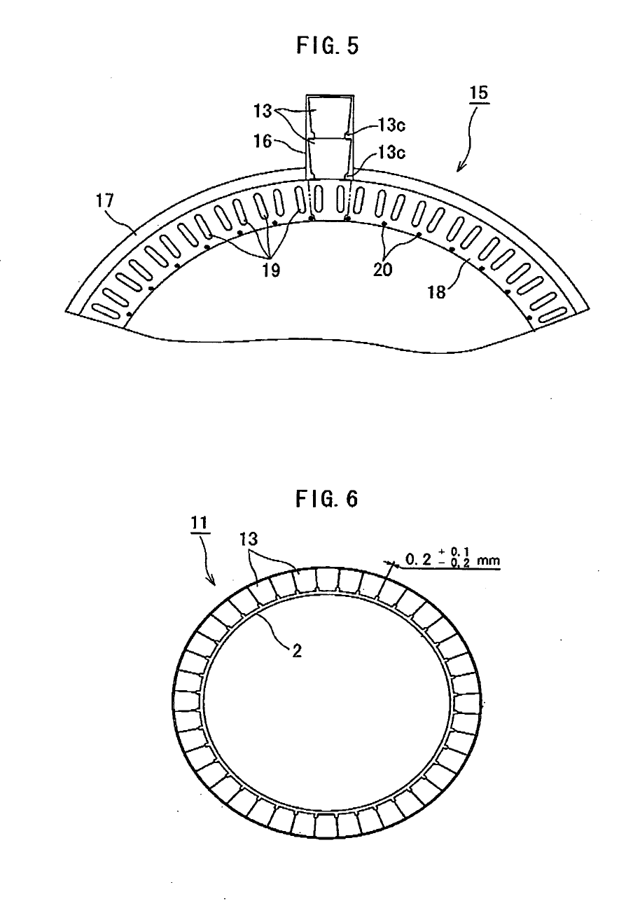

A segment-type friction material and its manufacturing method according to a second embodiment of the invention is described referring to FIG. 4 to FIG. 6. FIG. 4 is a plan view showing a segment piece of a segment-type friction material and its manufacturing method according to a second embodiment of the invention. FIG. 5 is a plan view showing a half of an arranging device for aligning the segment pieces of the segment-type friction material according to the second embodiment of the invention. FIG. 6 is a plan view showing a finished segment-type friction material of the second embodiment of the invention.

As shown in FIG. 4, the segment-type friction material 11 according to the second embodiment is composed of segment pieces 13. The segment pieces 13 have a left side 13a and a right side 13b that make an angle of 9 degrees therebetween. The segment-type friction material 11 has the segment pieces 13 arranged circumferentially and close to each other on one surface of a core metal 2. That is, an adjacent pair of the segment pieces 13 is disposed with very small gap or without a gap therebetween. Accordingly, a number of division of the segment pieces 13 in the ring-shaped segment-type friction material 11 becomes a number obtained by dividing a circumferential angle or 360 degrees by a center angle of each segment piece 13 or 9 degrees: 360/9=40 segments. Thus, the one surface the segment-type friction material 11 is composed of forty segment pieces 13. Cut portions 13c are provided on opposite inner peripheral corners of the segment piece 13, respectively. The left and right cut portions 13c have symmetric shapes, respectively, that are obtained by dividing an ellipse or a slot into four and that extend along the left side 13a and the right side 13b at inner ends thereof. Thus, a small elliptical or half-slot space is provided between the cut portions 13c of the adjacent segment pieces 13.

As shown in FIG. 4, the segment pieces 13 of such shape are disposed so as to make a ring shape as a whole by use of an arranging device 15. The arranging device 15 has a guide 16, an outside diameter guide 17 and a rotating device 18. The rotating plate 18 has an inside diameter and an outside diameter nearly equal to those of the core metal 2 of flat ring plate shape constituting the segment-type friction material 11. The rotating plate 18 determines and rotates 9 degrees at a time. Positioning suction holes 19 are provided as eighty through holes of an oval or slot shape extending along a radial direction of the rotating plate 18. The suction holes 19 do vacuum suck so as to fasten the arranged segment pieces 13 without displacement. Positioning pins 20 are put in an upright position near an inner circumference of the rotating plate 18 at every 9 degrees of the rotating plate 18. The guide 16 is connected to the rotating plate 18 so as to push out the segment pieces 13 one by one onto the rotating plate 18 by a not-shown pushing member. The outside diameter guide 17 is provided along the entire outer circumference of the rotating plate 18 except a part corresponding to the guide 16.

The segment pieces 13 are fed in the guide 16 in order. A head segment piece 13 is pushed out by the not-shown pushing member so as to be mounted on the rotating plate 18. At this time, the positioning pins 20 of the rotating plate 18 are located at positions where the cut portions 13c are provided at the opposite inner peripheral corners of the segment piece 13. Then, the pushed out segment piece 13 makes the cut portions 13c at the opposite inner peripheral corners fitted on two positioning pins 20, respectively. Thus, the segment piece 13 is positioned on the rotating plate 18. That is, each of the cut portions 13c of the segment piece 13 has such a shape as is engaged with the positioning pin 20 when the segment piece 13 is pushed out to the rotating plate 18, thereby positioning the segment piece 13. Then, the segment piece 13 positioned on a fixed location of the rotating plate 18 is vacuum-sucked through a pair of the positioning suction holes 19 that is located on a lower surface of the segment piece 13. Thus, the segment piece 13 is fastened on the rotating plate 18. In such state, the rotating plate 18 rotates 9 degrees. Then, a next segment piece 13 is pushed out, mounted on the rotating plate 18 and vacuum-sucked to be fastened at a fixed position.

When the above-described step is repeated and the rotating plate 18 goes into a 360 degrees role, forty segment pieces 13 are charged on the rotating plate 18 in a ring shape as a whole. At this time, a sucking/moving mechanism similar to that of the first embodiment is disposed so as to face an upper surface of the rotating plate 18. Moreover, each of the forty suction heads is disposed so as to face each of the segment pieces 13 mounted on the rotating plate 18. Then, each of all the suction heads of the sucking/moving mechanism sucks the front surface of each of the segment piece 13. At the same time, a sucking operation of the positioning suction holes 19 of the rotating plate 18 is stopped. The forty segment pieces 13 disposed in a ring shape are lifted by the sucking/moving mechanism and moved in parallel to the core metal 2 of the flat ring plate shape with an adhesive of a thermosetting synthetic resin applied on an entire front surface thereof. Then, the forty segment pieces 13 are pressed to the core metal 2 so as to adhere to the front surface of the core metal 2.

Next forty segment pieces 13 are positioned on the rotating plate 18 by the same step. The forty segment pieces 13 disposed in a ring shape are lifted by the sucking/moving mechanism in the same manner and moved in parallel to a rear surface of the core metal 2 that has the forty segment pieces 13 stuck on the front surface in the previous step. At this time, an adhesive is coated on an entire rear surface of the core metal 2. Then, the segment pieces 13 are pressed to the core metal 2 so as to adhere to the rear surface of the core metal 12. Then, the segment pieces 13 are pressed by a heat-press of 230° C. to 270° C. for 20 to 90 seconds from opposite surfaces of the core metal 2. Thus, the segment pieces 13 are firmly fixed on the opposite surfaces of the core metal 2. Thereby, the segment-type friction material 11 shown in FIG. 6 is obtained. As shown in FIG. 6, a gap between the adjacent segment pieces 13 of the segment-type friction material 11 falls within a range of 0.2 mm plus 0.1 mm or minus 0.2 mm.

A frictional characteristic or property of the segment-type friction material 11 will be described later collectively in comparison with the other embodiments, too.

### THIRD EMBODIMENT

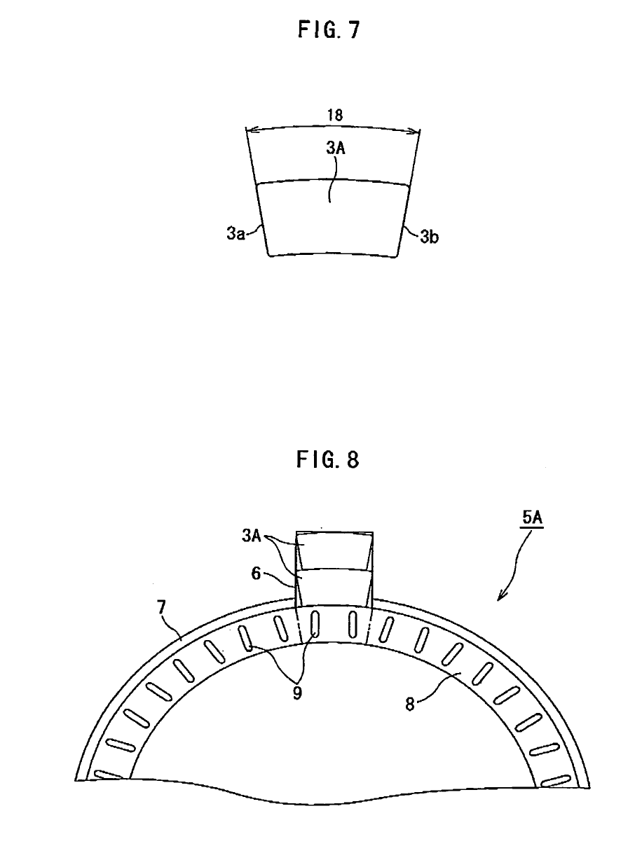

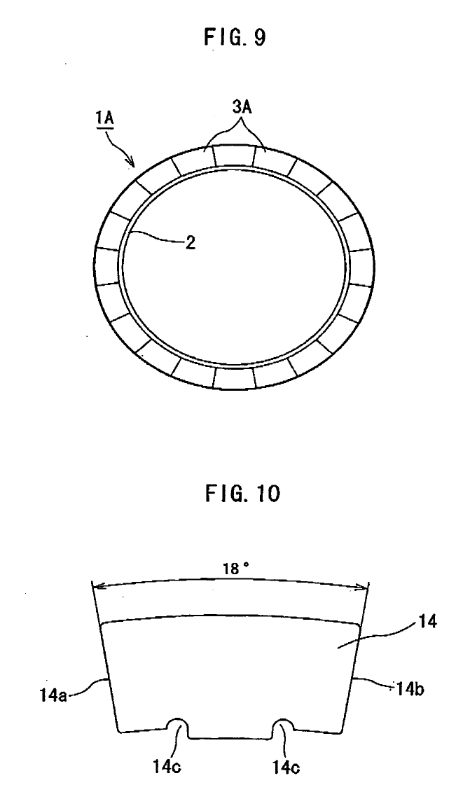

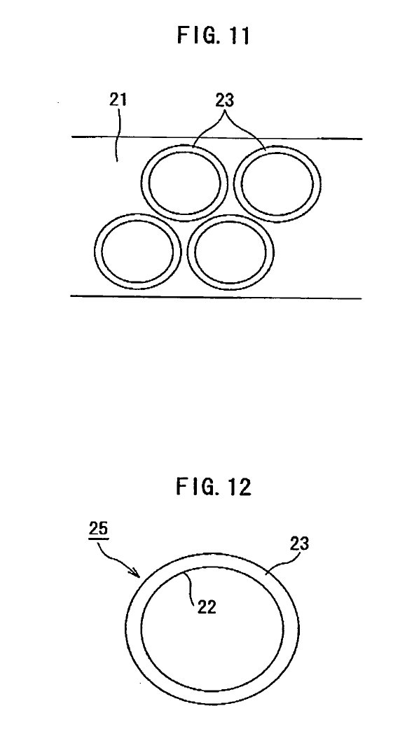

A segment-type friction material and its manufacturing method according to a third embodiment of the invention is described referring to FIG. 7 to FIG. 9. FIG. 7 is a plan view showing a segment piece of a segment-type friction material and its manufacturing method according to a third embodiment of the invention. FIG. 8 is a plan view showing a half of an arranging device for aligning the segment pieces of the segment-type friction material according to the third embodiment of the invention. FIG. 9 is a plan view showing a finished segment-type friction material of the third embodiment of the invention.

As shown in FIG. 7, a segment piece 3A of a friction material 1A according to the third embodiment has a similar shape and a dimension as those of the segment piece 3 of the first embodiment shown in FIG. 1. The segment piece 3A has a left side 3a and a right side 3b in the same way. The left side 3a and the right side 3b make an angle of 18 degrees, too. The friction material 1A has twenty segment pieces 3A stuck to each of the front surface and the rear surface of the core metal 2. On the other hand, the segment piece 3A of the third embodiment is different from the segment piece 3 of the first embodiment in that the segment piece 3A has no cut portions or notches at the outer circumferential corners as the notches 3c of the first embodiment. That is, the left side 3a and the right side 3b of the segment piece 3A each extends linearly from the inner end to the outer end.

Accordingly, as shown in FIG. 8, an arranging device 5A of the third embodiment has a similar structure to the arranging device 5 of the first embodiment shown in FIG. 2. In contrast, the arranging device 5A has no positioning pins 10. Thus, in the third embodiment, the segment piece 3A is positioned on the rotating plate 8, while no cut portions is provided on the segment piece 3A, only by the positioning suction holes 9 provided on the rotating plate 8. Specifically, in the third embodiment, each of the segment pieces 3A is fastened on a fixed position of the rotating plate 8 by a sucking operation of the positioning suction holes 9 at the time when a leading end or an inner side of the segment piece 3A pushed out onto the rotating plate 8 from the guide 6 reaches the inner circumference of the rotating plate 8. Thus, each of the segment pieces 3A can be positioned with sufficient precision on a fixed position of the rotating plate 8 even without the positioning pins 10.

With such structure, the segment pieces 3A without the cut portions are pushed out and positioned one by one onto the rotating plate 8, while rotating the rotating plate 8 by each 18 degrees. By repeating such step, the rotating plate 8 is charged with twenty segment pieces 3A. Then, each two of all the forty suction heads of the sucking/moving mechanism as used in the first and second embodiment suck the front surface of each of the segment pieces 3A. At the same time, the suction operation of the positioning suction holes 9 of the rotating plate 8 is stopped. Then, the sucking/moving mechanism lifts and moves in parallel the twenty segment pieces 3A arranged in a ring shape to the core metal 2. Thereafter, the twenty segment pieces 3A are pressed to the front surface of the core metal 2, while the entire front surface being coated with an adhesive of a thermosetting synthetic resin. Thus, the twenty segment pieces 3A adhere to the front surface of the core metal 2.

Next twenty segment pieces 3A are positioned on the rotating plate 8 in the same step. Then, the twenty segment pieces 3A arranged in the ring shape are lifted by the sucking/moving mechanism and moved in parallel to the rear surface of the core metal 2 with the twenty segment pieces 3A previously joined to the front surface thereof. Thereafter, the twenty segment pieces 3A are pressed to the rear surface of the core metal 2, while the entire rear surface being coated with the adhesive. Thus, the twenty segment pieces 3A adhere to the rear surface of the core metal 2. Then, the segment pieces 3A are pressed by a heat-press of 230° C. to 250° C. for 30 to 90 seconds from opposite surfaces of the core metal 2. Thus, the segment pieces 3A are firmly fixed on the opposite surfaces of the core metal 2. Thereby, the segment-type friction material 1A shown in FIG. 9 is obtained. As shown in FIG. 9, a gap between the adjacent segment pieces 3A of the segment-type friction material 1A falls within a range of 0.2 mm plus 0.1 mm or minus 0.2 mm.

### FOURTH EMBODIMENT

A segment-type friction material and its manufacturing method according to a fourth embodiment of the invention is described referring to FIG. 10. FIG. 10 is a plan view showing a segment piece of a segment-type friction material and its manufacturing method according to a fourth embodiment of the invention.

As shown in FIG. 10, a segment piece 14 constituting a segment-type friction material according to the fourth embodiment has a left side 14a and a right side 14b that make an angle of 18 degrees. Accordingly, the segment-type friction material divides its entire circumference into twenty divisions by an expression of 360/18=20. Thus, twenty segment pieces 14 constitute one surface of the segment-type friction material. This is the same as the first and the third embodiment. However, as shown in FIG. 10, the segment piece 14 of the fourth embodiment has two cut portions 14c that are located at an inner peripheral side of the segment piece 14 at an angle of 9 degrees. The cut portions 14c are fitted and engaged with positioning pins provided near the inner circumference of a rotating plate so as to position the segment piece 14 on the rotating plate.

Accordingly, an arranging device of the fourth embodiment is composed of the guide 6 and the outer circumferential guide 7 shown in FIG. 2 in addition to the rotating plate having the positioning suction holes 9 shown in FIG. 2 and the positioning pins 20 shown in FIG. 5. The steps and condition for manufacturing the segment-type friction material are the same as those of the first to the third embodiments. Therefore, their description is omitted for avoiding redundancy.

Evaluation Method

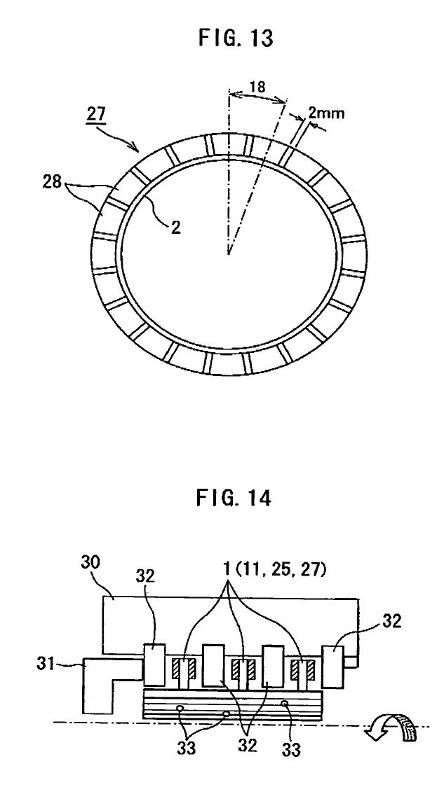

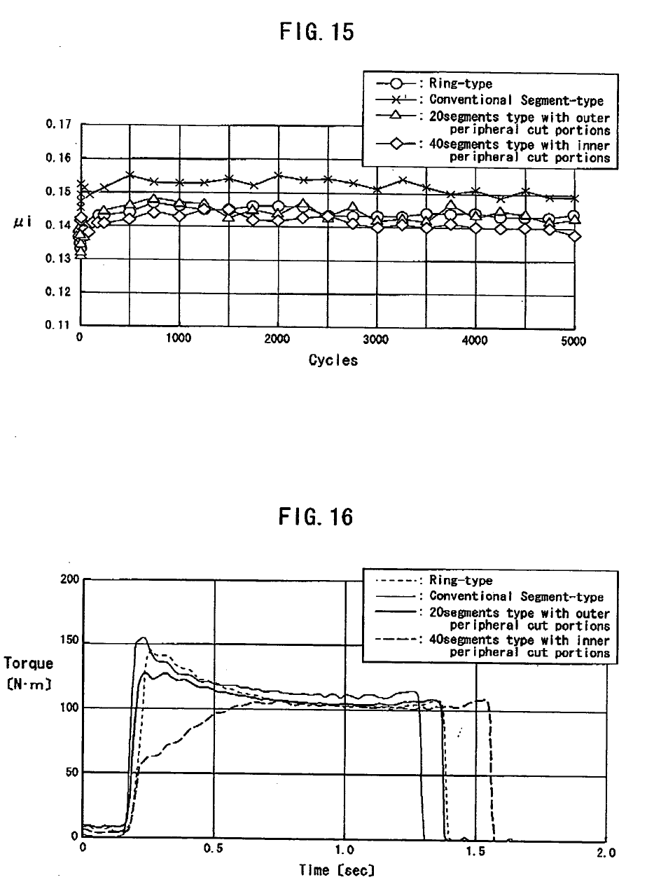

A frictional characteristic or property of the segment-type friction material according to each of the first to the fourth embodiments was evaluated in comparison with the conventional ring-type friction material 25 shown in FIG. 12 and the conventional segment-type friction material 27 shown in FIG. 13. FIG. 14 is a schematic view showing a test device for evaluate a frictional property of a segment-type friction material. FIG. 15 is a graph showing an evaluation result of a standard load duration evaluation. FIG. 16 is a graph showing an evaluation result of a μ-P-T performance evaluation.

As evaluation items, “standard load duration evaluation” and “μ-P-T performance evaluation” were conducted. As a tester, SAE#2 tester 30 was used as shown in FIG. 14. Three segment-type friction materials or three ring-type friction materials as test pieces were set between four plates 32. The SAE#2 tester 30 is a frictional characteristic testing machine corresponding to a test method of JASO (Japanese Automobile Standard Organization) M348-2002. A size of the segment-type friction material is 142.1 mm in the outside diameter and 117 mm in the inside diameter. The standard load duration evaluation was conducted under a condition that a frictional rotating speed is 3600 rpm, ON and OFF timing is ON/OFF=15 sec/15 sec, a face pressure by a piston 31 is 0.784 MPa, while running ATF as a lubricating oil through lubricating oil holes 33 by an oil amount of 600 ml/min at an oil temperature of 100° C. A result is shown in FIG. 15.

“Ring-type” in FIG. 15 corresponds to the ring-type friction material 25. “Conventional segment-type” corresponds to the conventional segment-type friction material 27. “20 segments type with outer peripheral cut portions” corresponds to the segment-type friction material 1 of the first embodiment. “40 segments type with outer peripheral cut portions” corresponds to the segment-type friction material 11 of the second embodiment. The segment-type friction materials of the third embodiment and the fourth embodiment are eliminated from the drawing, since they had the similar result as that of the segment-type friction material 1 of the first embodiment. As shown in FIG. 15, frictional coefficients μi in the standard load duration evaluation of the segment-friction material 1 of the first embodiment and the segment-type friction material 11 of the second embodiment remained lower than the conventional segment-type friction material 27. They showed a similar change to that of the ring-type friction material 25. Particularly, the “40 segments type with outer peripheral cut portions” always remained as low as or lower than that of the “Ring-type”. The “20 segments type with outer peripheral cut portions” showed generally the same value as that of the “Ring-type”.

From this result, it is found that the segment-type friction material with the very narrow gap between the segment pieces can obtain the frictional characteristic generally same as that of the ring-type friction material. In the segment-type friction material of each of the above-mentioned embodiments, a curvature of the inner peripheral side or an inner arc is set the same as a curvature of the outer peripheral side or arc in each of the segment pieces 3, 3A, 13, 14. Therefore, it is possible to cut out the segment pieces 3, 3A, 13, 14 successively in an up-and-down direction from the band-like friction material substrate in a cutting-out step. Moreover, it is possible to cut out the segment pieces 3, 3A, 13, 14 successively in a right-and-left direction from the band-like friction material substrate, if just a little interval is provided in the right-and-left direction. Consequently, a material yield improves up to 80% to 90%, thereby reducing costs largely in comparison with the ring-type friction material.

Next, the μ-P-T performance evaluation was conducted. The SAE#2 tester 30 shown in FIG. 14 was used as the tester. Three segment-type friction materials or three ring-type friction materials as test pieces were set between the four plates 32. Then, after finishing 200 cycles under the condition of the above-mentioned standard load duration evaluation, a torque waveform was measured at the time of engaging the four plates 32 with the three friction materials by the piston 31 under a condition of an oil temperature of 40° C. and a pressure of 0.392 Mpa. A result is shown in FIG. 16.

As shown in FIG. 16, the “conventional segment-type” or the conventional segment-type friction material 27 has the highest start-up torque. This is because the segment-type friction material 27 has radially extending oil grooves and the ATF rapidly goes out to an outside accordingly. Thus, the segment-type friction material 27 is firmly engaged with the plate 32 without making an oil film. If the start-up torque is high, a driver or the like of an automobile feels it as a shock or an impact. The “ring-type” or the ring-type friction material 25 has a lower start-up torque than the segment-type friction material 27. The “20 segments type with outer peripheral cut portions” or the segment-type friction material 1 of the first embodiment has a still lower start-up torque. Torque waveforms after the start-up are generally the same between the “ring-type” and the “20 segments type with outer peripheral cut portions”. Accordingly, the “20 segments type with outer peripheral cut portions” is available with no change as a replacement of the “ring-type”, thereby largely reducing the costs.

In case of the “40 segments type with outer peripheral cut portions” or the segment-type friction material 11 of the second embodiment, its torque has no start-up peak. The torque rises slowly from about 50N·m to about 100N·m. The reason is considered as follows. First, forty small dents are formed by pairs of the cut portions 13c of the adjacent segment pieces 13 at the inner circumference of the segment-type friction material 11. Then, the ATF flowing from inside gathers there, while an oil film is generated on the surface of the segment pieces 13. Thus, the segment-type friction material 11 is gently engaged with the plates 32. Such torque waveform is ideal as the ring-type friction material. Therefore, the segment-type friction material 11 is available as a replacement of the ring-type friction material depending on where it is used in the AT. Still, there are some cases where a tuning is necessary.

At any rate, the segment-type friction material 1 of the first embodiment, the segment-type friction material 11 of the second embodiment and the segment-type friction materials of the third and the fourth embodiments can be used as the replacement of the ring-type friction material. Moreover, they are compatible with a push-cut method, so that it is possible to assure productivity of an existing manufacturing line of segment-type friction materials. In addition, they can raise the material yield up to 80% to 90% in contrast to a material yield of 10% to 20% in the ring-type friction material.

Each of the above-described embodiments is described about the segment-type friction material that has the segment pieces secured on the opposite surfaces, as an example. However, the same function and effects can be obtained in a segment-type friction material that has the segment pieces only on one of the opposite surfaces.

The preferred embodiments described herein are illustrative and not restrictive, the scope of the invention being indicated in the appended claims and all variations which come within the meaning of the claims are intended to be embraced therein.

1. A segment-type wet friction material comprising:
a core metal of a flat ring plate shape; and
segment pieces made of a friction material substrate cut into a segment piece shape along a circumference of the flat ring plate shape of the core metal, the segment pieces being joined on at least one surface of the core metal with an adhesive, and the segment pieces being arranged side by side and in close contact with each other along the entire circumference of the core metal so as to substantially eliminate a gap between adjacent two of the segment pieces.

2. A segment-type wet friction material according to claim 1, in which:
each of the segment pieces has a same shape and a same dimension;
each of the segment pieces has a left side, a right side, an outer peripheral side and an inner peripheral side, while the left side and the right side of the segment piece making a prescribed angle; and
the prescribed angle made by the left side and the right side of each of the segment pieces is determined so that a predetermined number of the segment pieces are to be arranged side by side and in close contact with each other along the entire circumference of the core metal so as to substantially eliminate a gap between adjacent two of the segment pieces.

3. A segment-type wet friction material according to claim 2, in which the prescribed angle made by the left side and the right side of each of the segment pieces is eighteen degrees and twenty segment pieces as the predetermined number of the segment pieces are arranged side by side and in close contact with each other along the entire circumference of the core metal so as to substantially eliminate a gap between adjacent two of the segment pieces.

4. A segment-type wet friction material according to claim 2, in which the prescribed angle made by the left side and the right side of each of the segment pieces is nine degrees and forty segment pieces as the predetermined number of the segment pieces are arranged side by side and in close contact with each other along the entire circumference of the core metal so as to substantially eliminate a gap between adjacent two of the segment pieces.

5. A segment-type wet friction material according to claim 1, in which:
the segment pieces are disposed in a predetermined number side by side and in close contact to each other on a same plane so as to form a ring shape corresponding to the flat ring plate shape of the core metal, while each of the predetermined number of the segment pieces being positioned at a fixed location on the same plane, and the predetermined number of the segment pieces formed in the ring shape are integrally moved to the surface of the core metal so as to be joined thereto with the adhesive; and
each of the segment pieces has a reference point or a reference line that acts to position the same segment piece at the fixed location on the same plane.

6. A segment-type wet friction material according to claim 5, in which the segment piece has a cut portion acting as the reference point, the cut portion being provided at a fixed position of a periphery of the segment piece.

7. A segment-type wet friction material according to claim 2, in which:
the predetermined number of the segment pieces are disposed side by side and in close contact to each other on a same plane so as to form a ring shape corresponding to the flat ring plate shape of the core metal, while each of the predetermined number of the segment pieces being positioned at a fixed location on the same plane, and the predetermined number of the segment pieces formed in the ring shape are integrally moved to the surface of the core metal so as to be joined thereto with the adhesive; and
each of the segment pieces has a reference point or a reference line that acts to position the same segment piece at the fixed location on the same plane.

8. A segment-type wet friction material according to claim 7, in which the segment piece has a cut portion acting as the reference point, the cut portion being provided at a fixed position of at least one of the left side, the right side, the outer peripheral side and the inner peripheral side of the segment piece.

9. A segment-type wet friction material according to claim 8, in which the fixed position and a shape of the cut portion of each of the predetermined number of the segment pieces is determined such that the cut portion is fitted and engaged with a positioning pin provided on the same plane when the predetermined number of the segment pieces are disposed side by side on the same plane, thereby enabling each of the predetermined number of the segment pieces to be positioned at each of the fixed locations on the same plane.

10. A segment-type wet friction material according to claim 9, in which a pair of the cut portions is provided at an outer left corner between the left side and the outer peripheral side and at an outer right corner between the right side and the outer peripheral corner of the segment piece, the pair of the cut portions being made by symmetric short straight lines that extend in parallel to each other while crossing the left side and the right side at a small angle at outer ends of the left side and the right side, respectively.

11. A segment-type wet friction material according to claim 9, in which a pair of the cut portions is provided at an inner left corner between the left side and the inner peripheral side and at an inner right corner between the right side and the inner peripheral corner of the segment piece, the pair of the cut portions having symmetric shapes, respectively, that are obtained by dividing an ellipse or a slot into four and that extend along the left side and the right side at inner ends thereof.

12. A segment-type wet friction material according to claim 9, in which a pair of the cut portions is provided at the inner peripheral side of the segment piece, the pair of the cut portions being separated at a half angle of the prescribed angle made by the left side and the right side of the segment piece.

13. A segment-type wet friction material according to claim 7, in which the inner peripheral side of the segment piece defines the reference line.

14. A segment-type wet friction material according to claim 2, in which the outer peripheral side and the inner peripheral side of the segment piece has substantially a same curvature.

15. A manufacturing apparatus of a segment-type wet friction material according to claim 6, comprising:
a rotating plate of a ring shape corresponding to the core metal, the rotating plate being able to arrange and set the segment pieces side by side and in close contact with each other along an entire circumference thereof so as to substantially eliminate a gap between adjacent two of the segment pieces; and
a guide for guiding a movement of the segment piece to the rotating plate;
wherein the rotating plate has positioning pins erected thereon in a predetermined number larger than a number of the segment pieces joined on one surface of the core metal, the rotating plate has positioning suction holes provided in a predetermined number larger than the number of the segment pieces, each of the positioning pins fits into the cut portion of each of the segment pieces guided from the guide and set on the rotating plate so as to position the segment piece at a fixed location of the rotating plate, and each of the positioning suction holes sucks each of the segment pieces positioned at the fixed location so as to keep the segment piece fastened at the fixed location.

16. A manufacturing apparatus of a segment-type wet friction material according to claim 15, in which the guide guides the movement of the segment piece one by one to the rotating plate, each of the positioning pins of the rotating plates is disposed at a position matching each of the cut portions of each of the segment pieces guided to the rotating plate, and the positioning pins are provided in a same number as a number of the cut portions of the segment pieces.

17. A manufacturing apparatus of a segment-type wet friction material according to claim 5, comprising:
a rotating plate of a ring shape corresponding to the core metal, the rotating plate being able to arrange and set the segment pieces side by side and in close contact with each other along an entire circumference thereof so as to substantially eliminate a gap between adjacent two of the segment pieces; and
a guide for guiding a movement of the segment piece to the rotating plate;
wherein the rotating plate has positioning suction holes provided thereon in a predetermined number larger than a number of the segment pieces joined on one surface of the core metal and control means for detecting an inner peripheral side as the reference line of each of the segment pieces guided from the guide and set on the rotating plate and then operating the positioning suction holes when the inner peripheral side coincides with an inner circumferential edge of the rotating plate so as to sucking the segment piece by the positioning suction hole and thereby to position the segment piece on a fixed location of the rotating plate.

18. A manufacturing method of a segment-type wet friction material according to claim 5, comprising:
a cutting step for cutting the segment pieces from the friction material substrate into the segment piece shape;
a setting step for guiding a movement of the segment pieces to a rotating plate one by one via a guide so as to position each of the segment pieces at a fixed location of the rotating plate and sucking each of the segment pieces positioned at the fixed location by a positioning suction hole provided on the rotating plate so as to keep each of the segment pieces fastened at the fixed location, the setting step being repeated by a number of the segment pieces arranged on one surface of the core metal so as to arrange and set the segment pieces side by side and in close contact with each other along an entire circumference thereof and so as to substantially eliminate a gap between adjacent two of the segment pieces;
a sucking step for integrally sucking and holding all the segment pieces arranged side by side on the rotating plate by all suction heads of a sucking/moving mechanism, while stopping sucking operation of the positioning suction holes of the rotating plate, after the rotating plate turns 360 degrees and all the segment pieces are arranged in close contact with each other into the ring shape; and
an adhering step for integrally lifting and moving in parallel all the segment pieces arranged into the ring shape to the core metal with the adhesive coated on one surface and then integrally pressing and joining all the segment pieces to the core metal via the sucking/moving mechanism.

19. A manufacturing method of a segment-type wet friction material according to claim 6, comprising:
a cutting step for cutting the segment pieces from the friction material substrate into the segment piece shape;
a setting step for guiding a movement of the segment pieces to a rotating plate one by one via a guide so as to make each of positioning pins erected on the rotating plate in each of the cut portions of each of the segment pieces thereby to position each of the segment pieces at a fixed location of the rotating plate and sucking each of the segment pieces positioned at the fixed location by a positioning suction hole provided on the rotating plate so as to keep each of the segment pieces fastened at the fixed location, the setting step being repeated by a number of the segment pieces arranged on one surface of the core metal so as to arrange and set the segment pieces side by side and in close contact with each other along an entire circumference thereof and so as to substantially eliminate a gap between adjacent two of the segment pieces;
a sucking step for integrally sucking and holding all the segment pieces arranged side by side on the rotating plate by all suction heads of a sucking/moving mechanism, while stopping sucking operation of the positioning suction holes of the rotating plate, after the rotating plate turns 360 degrees and all the segment pieces are arranged in close contact with each other into the ring shape; and
an adhering step for integrally lifting and moving in parallel all the segment pieces arranged into the ring shape to the core metal with the adhesive coated on one surface and then integrally pressing and joining all the segment pieces to the core metal via the sucking/moving mechanism.

20. A manufacturing method of a segment-type wet friction material according to claim 5, comprising:
a cutting step for cutting the segment pieces from the friction material substrate into the segment piece shape;
a setting step for guiding a movement of the segment pieces to a rotating plate one by one via a guide, then detecting an inner peripheral side as the reference line of each of the segment pieces so as to operate a positioning suction hole provided on the rotating plate so as to suck the segment piece and to keep the segment piece fastened at a fixed location of the rotating plate, the setting step being repeated by a number of the segment pieces arranged on one surface of the core metal so as to arrange and set the segment pieces side by side and in close contact with each other along an entire circumference thereof and so as to substantially eliminate a gap between adjacent two of the segment pieces;
a sucking step for integrally sucking and holding all the segment pieces arranged side by side on the rotating plate by all suction heads of a sucking/moving mechanism, while stopping sucking operation of the positioning suction holes of the rotating plate, after the rotating plate turns 360 degrees and all the segment pieces are arranged in close contact with each other into the ring shape; and
an adhering step for integrally lifting and moving in parallel all the segment pieces arranged into the ring shape to the core metal with the adhesive coated on one surface and then integrally pressing and joining all the segment pieces to the core metal via the sucking/moving mechanism.
